(19) United States
(12) Patent Application Publication
(10) Pub. No.: US 2025/0222421 A1
(43) Pub. Date: Jul. 10, 2025

(54) HIERARCHICAL CORE-SATELLITE PARTICLES AND METHODS OF PREPARATION THEREOF

(71) Applicant: City University of Hong Kong, Hong Kong (CN)

(72) Inventor: Chia-Hung CHEN, Hong Kong (CN)

(21) Appl. No.: 18/404,976

(22) Filed: Jan. 5, 2024

(51) Int. Cl. B01J 13/10; B01J 13/00

(52) U.S. Cl. CPC B01J 13/10; B01J 13/0065

(57) ABSTRACT

A method of preparing hierarchical core-satellite particles, the method comprising: contacting charged microparticles comprising a first charge, charged nanoparticles comprising a second charge, and a charged binding material selected from the group consisting of charged small molecules and charged polymers, wherein the charged small molecules or the charged polymers comprise a third charge in a solvent thereby forming the hierarchical core-satellite particles, wherein the first charge and the second charge are both positively charged or negatively charged, the third charge is the opposite charge of the first charge and the second charge, and the average size of the charged microparticles is at least about 10³ times larger than the average size of the charged nanoparticles.

### TECHNICAL FIELD

The present disclosure relates to methods for preparing hierarchical core-satellite particles.

### BACKGROUND

The assembly of simple building blocks into functional superstructures with long-range ordering hierarchical architectures is of wide significance to construct engineering materials. Over decades of innovation, sequential electrostatic layer-by layer (LbL) assembly has proven to be a versatile approach to fabricate long-range ordered uniform multilayer configurations on substrates. These LbL multilayers display nanoscale resolution with controlled thickness, layered architectures and tailored physical/chemical properties for drug delivery, photonics, chemical sensing, energy storage and catalysis, etc. However, a lab-intensive protocol of sequentially adding oppositely charged components and cycled rinsing steps is usually required to avoid contamination between each adsorbed layer, which may cause overcompensation or overcharging of opposite components and result in unwanted aggregation. Although many automatic platforms have been developed to fabricate sequential LbL assemblies, the complex deposition cycles and frequent rinsing steps have remarkably disadvantaged their industrial application for large-scale production. In fact, frequent rinsing steps may result in wasted feedstock by reducing the adsorbed composition, with ˜10% of the loosely adsorbed charged layer being washed away by 5 minutes of water that can cause unavoidable assembly defects and lowered yield. Indeed, single-step electrostatic LbL nanotechnologies in one-pot dispersions that can spontaneously drive oppositely charged components and mediate them to assemble on substrates in an LbL manner, without complex solution replacement and wasted feedstock is desirable for hierarchical assembly on large-scale, and remains a challenge in materials science.

Hierarchical core-satellite particles were constructed by conjugating microparticles (MPs) as the cores and nanoparticles (NPs) as shells are novel hybrid material with enhanced multifunction. First, the functions of the hybrid materials are determined by the morphology of nanocoated shells, such as NP density, NP geometrical shapes, NP arrangement, and configurations of multilayer nanocoating. Notably, although sequential LbL approach can be conducted to prepare the hierarchical core-satellite particles with uniform and thickness-controllable multilayer nanocoating on MPs cores, the NP geometry and multilayered shell arrangement cannot be controlled during the assembly process. This is because when mixing, the oppositely charged pairs precipitate and deposit on the MP core rapidly and randomly, without sufficient reaction time for geometry and arrangement changes. Second, by using sequential LbL electrostatic assembly, NPs are usually limited to be coated on spherical MP cores. The challenges to form conformal and uniform LbL nanocoatings on non-spherical MPs cores with geometric asymmetry remains. The surface tension of the dispersion and the capillary forces generated during repeated rinsing may lead to NPs aggregation, ultimately resulting in non-conformal and non-uniformly overcoated multilayers in the confined and irregular nanostructured regions of non-spherical MPs cores. The above two points limit current sequential LbL nanotechnology to further construct the diverse multiscale long-range ordered core-satellite superstructure with rich morphologies and multifunctionality.

In general, building blocks exhibiting opposite charges such as molecules, polymers, NPs and MPs can attract and aggregate with each other when mixed. This principle guides a fast alternating adsorption of oppositely charged components, for example in the classical sequential electrostatic LbL assembly of polyanion (poly(sodium-p-styrenesulfonate) (PS)) and polycation (poly(diallyl dimethyl ammonium chloride) (PDDA)) on MPs core, the rapid assembly of highly overlapping polyelectrolyte multilayers from solution typically requires opposite charge components on similar length scales, allowing for equal charges and 1:1 stoichiometry (FIG. 1a-b). However, such conventional multistep procedures for sequential electrostatic LbL assembly are lab intensive and usually require many rinsing steps that inevitably cause inhomogeneous geometric features or defeats on the substrates.

There is thus a need for improved methods for preparing hierarchical core-satellite particles that address at least some of the disadvantages described above.

### SUMMARY

Sequential LbL processes typically require oppositely charged partners that are similarly sized, ensuring that electrically neutral solids readily precipitate from solution. In contrast, relatively little attention has been devoted to studying electrostatic interactions at interfaces across length scales, that is, between charged MPs, NPs and small molecules with different specific surface areas that bear opposite charges. Herein, we find that electrostatic interactions at interfaces with specific surface area across approximately 10¹⁰ orders of magnitude on length scales show some notable differences, that is, the mixtures of the same charged NPs (˜80 nm) or MPs (˜10 μm) and oppositely charged small molecules (approximately ˜0.1 nm) can remain in a stable state without forming aggregations over time in a range of NP/MP ratios and concentrations. On this basis, the interparticle attraction mediated by small molecules through a gradually decreasing equipotential difference (EPD) leads to the spontaneous alternate assembly of NPs and molecules around the counterpart MPs cores in a single-step LbL manner, and further prepares 3D core-satellite superstructures with uniform and precisely thickness-controllable nanocoating shells at the submicron scale. In addition, two unique advantages of the single-step LbL assembly were demonstrated. First, this strategy allowed NP shape changes in the dispersion from spherical to non-spherical geometry. The NPs were simultaneously assembled onto the MPs core, thus controlling the arrangement of nanocoated shells from dense to porous stacks with uniform multilayers. Second, the single-step LbL process eliminated repeated rinsing and the resulting surface tension and capillary forces in sequential LbL assembly, avoiding non-conformable and non-uniform overcoating assembled in confined and irregular nanostructured regions of non-spherical MPs to allow successful loading of conformal and uniform multilayer nanocoated shells on non-spherical MPs cores. Thus, the single-step LbL approach described herein is a flexible means for constructing different morphological core-satellite architectures in the NP shells and the MPs cores. Rich superstructures with diverse and controllable internal structures were approached through programmable combinational assembly procedures.

Notably, the batch-assembly of superstructure in bulk may lead to inhomogeneity due to the sedimentation tendency of MPs under gravity to affect yield. To overcome this challenge, mono-dispersed water-in-oil micro-droplets (˜30 μm in diameter) were generated through microfluidics as the micro-reactors with uniform conditions to perform the one-pot LbL assembly in parallel for the massive production (˜10⁴ particles per experiment). By uploading various charged components (wires, polymers and metal oxide particles) within the droplets, high-quality hierarchical core-satellite particles consisting of different components were approached. By exploring single-step LbL technology with microfluidics, the simple building blocks were constructed and assembled with long-range orders to form hybrid materials with hierarchical architectures on large scale for distinct technological applications.

In a first aspect, provided herein is a method of preparing hierarchical core-satellite particles, the method comprising: contacting charged microparticles comprising a first charge, charged nanoparticles comprising a second charge, and a charged binding material selected from the group consisting of charged small molecules and charged polymers, wherein the charged small molecules or the charged polymers comprise a third charge in a solvent, whereby:
(a) the charged binding material self-assembles on a surface the charged microparticles thereby forming a first self-assembled charged binding material monolayer comprising the charged binding material disposed on the surface of the charged microparticles;
(b) the charged nanoparticles self-assemble on a surface of the self-assembled charged binding material monolayer thereby forming a first self-assembled charged nanoparticle monolayer comprising the charged nanoparticles disposed on the surface of the first self-assembled charged binding material;
(c) the charged binding material optionally self-assembles on the first self-assembled charged nanoparticle monolayer thereby forming a second self-assembled charged binding material monolayer comprising the charged binding material disposed on the surface of the first self-assembled charged nanoparticle monolayer;
(d) the charged nanoparticles optionally self-assemble on a surface of the second self-assembled charged binding material thereby forming a second self-assembled charged nanoparticle monolayer comprising the charged nanoparticles disposed on the surface of the second self-assembled charged binding material monolayer; and
(e) optionally repeating step (c) or steps (c) and (d) one or more times;
   thereby forming the hierarchical core-satellite particles, wherein the first charge and the second charge are both positively charged or negatively charged, the third charge is the opposite charge of the first charge and the second charge, and the average size of the charged microparticles is at least about 10³ times larger than the average size of the charged nanoparticles.

In certain embodiments, the method is conducted in one reaction vessel in a single step.

In certain embodiments, the charged microparticles and the charged nanoparticles independently comprise charged silica, a metal oxide, or a polymer comprising at least one of a cationic functional group and an anionic functional group.

In certain embodiments, the cationic functional group is selected from the group consisting of an ammonium, an iminium, a guanidinium, a phosphonium, a sulfonium, an imidazolium, a thiazolium, pyrazolium, a pyridinium, a pyrrolidinium, a piperidinium, pyridazinium, pyrazinium, and pyrimidinium; and the anionic functional group is selected from the group consisting of carboxylate, sulfate, and phosphate.

In certain embodiments, the polymer comprises poly(dimethyldiallyl amine), poly(allylamine); poly(diallylmethyl amine); poly(ethylene imine), poly-ornithine, poly-arginine, poly-lysine, protamine, chitosan, a protein, poly(styrene sulfonic acid), poly(styrene carboxylic acid), poly(styrene phosphoric acid), poly(acrylic acid), poly(methacrylic acid), poly(vinylsulfonic acid), poly(vinylphosphoric acid), poly(itaconic acid), poly-glutamic acid, alginic acid, dextran sulfonic acid, hyaluronic acid, hydroxypropyl methyl cellulose pectin, heparin, carrageenan, a polynucleic acid, a protein, or a charged dendrimer.

In certain embodiments, the metal oxide is a Group 3-16 metal oxide.

In certain embodiments, the charged small molecules are an alkyl silane comprising a cationic functional group or an anionic functional group.

In certain embodiments, the cationic functional group is selected from the group consisting of an ammonium, an iminium, a guanidinium, a phosphonium, a sulfonium, an imidazolium, a thiazolium, pyrazolium, a pyridinium, a pyrrolidinium, a piperidinium, pyridazinium, pyrazinium, and pyrimidinium; and the anionic functional group is selected from the group consisting of carboxylate, sulfate, sulfonate, phosphate, and phosphonate.

In certain embodiments, the alkyl silane has a formula Y(CR¹₂)ₘ Si(R²)(OR³)₂, wherein m is a whole number selected from 1-10; Y is —COO⁻, —(P═O)(O⁻)₂, —O(P═O)(O⁻)₂, —(S═O)₂O⁻, —O(S═O)₂O⁻, —NR₃⁺, —SR₂⁺, —PR₃⁺, or a cationic heteroaryl, wherein R for each instance is independently hydrogen or alkyl; R¹ for each instance is independently hydrogen or alkyl; R² is alkyl or —OR³; and R³ for each instance is independently alkyl; or two R³ taken together with the oxygen to which they are bonded form 5-6 membered heterocyclic ring.

In certain embodiments, the alkyl silane has a formula NH₃⁺(CH₂)ₘSi(R²)(OR³)₂, wherein m is a whole number selected from 1-10; R² is alkyl or —OR³, and R³ for each instance is independently alkyl.

In certain embodiments, the alkyl silane undergoes a sol-gel reaction.

In certain embodiments, the charged microparticles and charged nanoparticles are a polymer comprising sulfonate or —NR—, and the charged small molecules are an alkyl silane has a formula NH₃(CH₂)ₘSi(OR³)₃, wherein m is a whole number selected from 1-10 and R³ for each instance is independently alkyl; or the charged microparticles and charged nanoparticles are negatively charged silica and the charged polymer comprises —NR₃⁺, wherein R for each instance is independently hydrogen or alkyl.

In certain embodiments, the charged binding material is present in the solvent at a concentration of at least 10³ times less than the concentration of the charged microparticles or the charged nanoparticles.

In certain embodiments, the solvent is water.

In certain embodiments, the solvent is an oil continuous phase comprising one or more water-in-oil micro-droplets comprising the charged microparticles, the charged nanoparticles, the charged binding material, and water.

In certain embodiments, the one or more water-in-oil micro-droplets are produced by a microfluidic device.

In certain embodiments, the charged microparticles and the charged nanoparticles are independently spherical, hollow, ellipsoidal, polyhedral, rod-shaped, plate-shaped, irregularly shaped, or a mixture thereof.

### BRIEF DESCRIPTION OF THE DRAWINGS

The foregoing aspects and many of the attendant advantages of this invention will become more readily appreciated and understood by reference to the following detailed description, when taken in conjunction with the accompanying drawings.

FIG. 1 depicts schematic images to indicate the differences between single-step LbL assembly and sequential LbL assembly. a, Sequential electrostatic LbL assembly of polyanion and polycation on MPs core. b, Rapid aggregation of oppositely charged polyelectrolytes on similar length scales in a 1:1 stoichiometry. c, Various MPs, NPs and small molecules with different specific surface area and geometries (A1, B1, C1, A2, B2, and C2) are stable mixed for single-step LbL assembly. d, Negatively charged PS MPs (10 μm), NPs (80 nm), and positive charged small molecules, such as 3-ammoniumpropyl triethoxysilane (APTESX-0.1 nm) is used to construct the superstructures. e, APTES-mediated interparticle potential difference (PD) as a driving force for PS NPs to attach around the PS MP core. f, Single-step LbL assembly of NPs (80 nm) and APTES (˜0.1 nm) on PS MPs cores. g-h, Single-step LbL assembly of coacervate NPs and APTES (˜0.1 nm) on PS MPs cores to obtain dense or porous nanoshells. i-k, Various core-satellite superstructures assembled from programmable ternary systems.

FIG. 2 depicts the assembly of the NPs around MPs cores driven by molecule-mediated PD. a, Schematic images show PS NPs and MPs adsorb APTES to form PS NP@APTES and PS MP@APTES. b, Schematic images show the different absorption capacity of APTES on the two particle surfaces with increasing assembly time and concentration of APTES (C_{APTES}) leading to PD. c, Schematic images show each binary system experiences from a stable, metastable to unstable state. d, e, Average particle size and zeta potential of PS NP/APTES dispersion as a function of time and concentration of APTES. f, Average zeta potential of PS MP/APTES dispersion as a function of time and concentration of APTES. g, h, TEM images and EDS analysis of the three states after adding 100 μL of APTES for solution 63 h. i, Infrared reflection spectra of PS@APTES NPs after adding 100 μL of APTES solution for 63 h. j, Interparticle PD between PS MPs and PS NPs was mediated after adding 100 μL APTES solutions. k, QCM-D results of using the mixed dispersion of negatively charged PS NPs and 100 μL APTES on the negatively charged chips deposited with PS MPs. l, Surface SEM images of PS MPs@APTES assembled with sparse PS NPs when the mixed dispersion was injected into QCM-D chamber for 800 min.

FIG. 3 depicts single-step LbL assembly of PS NPs around the PS MPs cores in ternary model. a, Schematic images I, IL, III, and IV show the preparation of MP@poly(silsesquioxane) and its chemical structure. b, Schematic images I, II, and III show the single-step LbL equipotential configuration and assemble mechanism. QCM-D results of using c, the mixed dispersion of PS NPs and APTES and d, the PS NPs dispersion on the chips deposited with positively charged PS MP@poly(silsesquioxane), and e, the mixed dispersions of PS NPs and APTES on chips deposited with MP without charge. f, Zeta potential of carboxyl group functional MP, PS MP@APTES and PS MP@poly(silsesquioxane). g, Change of the zeta potential of the assembled MPs and the PS NP@APTES with the assembly time. h, XPS results and the corresponding survey spectra of the PS nanocoatings assembled on the chips deposited with PS MP@poly(silsesquioxane) at the time of 0, 10 and 20 h. i, QCM-D results of the assembly by using the mixed dispersions containing 100, 130, 150 μL of APTES solutions, respectively. j-o, SEM images of the resultant PS nanocoatings on PS MPs cores at the different stages in (c-e).

### DETAILED DESCRIPTION

### Definitions

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the word “include” or variations such as “includes” or “including”, will be understood to imply the inclusion of a stated integer or group of integers, but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

As used herein, a “polymeric compound” (or “polymer”) refers to a molecule including a plurality of one or more repeating units connected by covalent chemical bonds. A polymeric compound can be represented by General Formula I:

*-(-(Ma)ₓ-Mb)_{y}-)_{z}* General Formula I

wherein each Ma and Mb is a repeating unit or monomer. The polymeric compound can have only one type of repeating unit as well as two or more types of different repeating units. When a polymeric compound has only one type of repeating unit, it can be referred to as a homopolymer. When a polymeric compound has two or more types of different repeating units, the term “copolymer” or “copolymeric compound” can be used instead. For example, a copolymeric compound can include repeating units where Ma and Mb represent two different repeating units. Unless specified otherwise, the assembly of the repeating units in the copolymer can be head-to-tail, head-to-head, or tail-to-tail. In addition, unless specified otherwise, the copolymer can be a random copolymer, an alternating copolymer, or a block copolymer. For example, General Formula I can be used to represent a copolymer of Ma and Mb having x mole fraction of Ma and y mole fraction of Mb in the copolymer, where the manner in which comonomers Ma and Mb is repeated can be alternating, random, regiorandom, regioregular, or in blocks, with up to z comonomers present. In addition to its composition, a polymeric compound can be further characterized by its degree of polymerization (n) and molar mass (e.g., number average molecular weight (M) and/or weight average molecular weight (Mw) depending on the measuring technique(s)). The polymers described herein can exist in numerous stereochemical configurations, such as isotactic, syndiotactic, atactic, or a combination thereof.

Provided herein is a method of preparing hierarchical core-satellite particles, the method comprising: contacting charged microparticles comprising a first charge, charged nanoparticles comprising a second charge, and a charged binding material selected from the group consisting of charged small molecules and charged polymers, wherein the charged small molecules or the charged polymers comprise a third charge in a solvent, whereby:
(a) the charged binding material self-assembles on a surface the charged microparticles thereby forming a first self-assembled charged binding material monolayer comprising the charged binding material disposed on the surface of the charged microparticles;
(b) the charged nanoparticles self-assemble on a surface of the self-assembled charged binding material monolayer thereby forming a first self-assembled charged nanoparticle monolayer comprising the charged nanoparticles disposed on the surface of the first self-assembled charged binding material;
(c) the charged binding material optionally self-assembles on the first self-assembled charged nanoparticle monolayer thereby forming a second self-assembled charged binding material monolayer comprising the charged binding material disposed on the surface of the first self-assembled charged nanoparticle monolayer;
(d) the charged nanoparticles optionally self-assemble on a surface of the second self-assembled charged binding material thereby forming a second self-assembled charged nanoparticle monolayer comprising the charged nanoparticles disposed on the surface of the second self-assembled charged binding material monolayer; and
(e) optionally repeating step (c) or steps (c) and (d) one or more times;
   thereby forming the hierarchical core-satellite particles, wherein the first charge and the second charge are both positively charged or negatively charged, the third charge is the opposite charge of the first charge and the second charge, and the average size of the charged microparticles is at least about 10³ times larger than the average size of the charged nanoparticles.

In instances in which both steps (c) and (d) are repeated one or more times, step (c) can optionally be repeated once.

In certain embodiments, the first charge and the second charge are both positively charged; and the third charge is negatively charged. In certain embodiments, the first charge and the second charge are both negatively charged; and the third charge is positively charged.

The charged microparticles and the charged nanoparticles can independently comprise charged silica, a metal oxide, or a polymer comprising at least one of a cationic functional group and an anionic functional group.

Charged silica can be prepared according to any method known in the art and can comprise a net negative charge or a net positive charge. The charge of charged silica can be modified by appropriate application of surface functionalization and/or coatings. Methods for preparing charged silica are well known in the art.

The metal oxide is not particularly limited and can comprise any negatively charged or positively charged metal oxide. In certain embodiments, the metal oxide is a Group 1, Group 2, Group 3, Group 4, Group 5, Group 6, Group 7, Group 8, Group 9, Group 10, Group 11, Group 12, Group 13, Group 14, Group 15, or Group 16 metal oxide. The metal oxide can comprise an alkali metal, such as lithium sodium, potassium, rubidium, and cesium, a alkaline earth metal, such as beryllium, magnesium, calcium, scandium, and barium, a transition metal, such as scandium, titanium, vanadium, chromium, manganese, iron, cobalt, nickel, copper, zinc, yttrium, zirconium, niobium, molybdenum, technetium, ruthenium, rhodium, palladium, silver, cadmium, lutetium, hafnium, tantalum, tungsten, rhenium, osmium, iridium, platinum, gold, and mercury, a post-transition metal, such as aluminum, gallium, indium, thallium, tin, lead, bismuth, polonium, astatine, and metalloids, such as boron, silicon, germanium, arsenic, antimony, and tellurium. The metal oxide can comprise a Group 1-16 metal in the +1, +2, +3, +4, +5, +6, or +7 oxidation state. In certain embodiments, the metal oxide comprises a noble metal catalyst (such as Ru, Rh, Pd, Ag, Os, Ir, Pt, and Ag) or a non-noble metal catalyst (such as Fe, Co, Ni, and Cu). In certain embodiments, the metal oxide comprises V²⁺, V³⁺, V⁴⁺, V⁵⁺, Cr²⁺, Cr³⁺, Cr⁶⁺, Fe²⁺, Fe³⁺, Co²⁺, Co³⁺, Ni²⁺, Ni³⁺, Cu¹⁺, Cu²⁺, Zn¹⁺, Mo²⁺, Mo³⁺, Mo⁴⁺, Mo⁵⁺, Mo⁶⁺, Se²⁺, Se⁴⁺, Sn²⁺, Sn⁴⁺, Pt²⁺, Pt⁴⁺, Ru²⁺, Ru³⁺, Ru⁴⁺, Ru⁵⁺, Ru⁶⁺, Pd²⁺, Pd⁴⁺, W²⁺, W³⁺, W⁴⁺, W⁵⁺, W⁶⁺, Ir¹⁺, Ir³⁺, Os³⁺, Os⁴⁺, Os⁵⁺, Os⁶⁺, Rh¹⁺, Rh³⁺, Nb³⁺, Nb⁴⁺, Nb⁵⁺, Ta³⁺, Ta⁴⁺, Ta⁵⁺, Pb²⁺, Pb⁴⁺, Bi¹⁺, Bi²⁺, Au¹⁺, Au³⁺, Ag¹⁺, Sc³⁺, or Y³⁺. Exemplary metal oxides include, but are not limited to, CoO₃, Co₃O₄, CoO, CuO, Cu₂O, NiO, Ni₂O₃, Ag₂O, AgO, FeO, Fe₂O₃, Fe₃O₄, ZnO, PdO, PdO₂, PtO, and PtO₂.

The polymers used in the methods described herein are not particularly limited and all types of polymers comprising a negative charge or a positive charge are contemplated. In certain embodiments, the polymer is a zwitterionic species comprising both negatively charged moieties and positively charged moieties, and which comprises a net positive charge or a net negative charge.

The polymer can be a liner polymer, branched polymer, or a dendrimer. In certain embodiments, the polymer is crosslinked.

The polymer can comprise one or more repeating units selected from the group consisting of ethylene, propylene, butadiene, styrene, acrylonitrile, carbonate, lactate, acrylate, methacrylate, ethylene glycol, propylene glycol, and vinyl chloride. Exemplary polymers comprise polymeric moieties selected from the group consisting of polyurethane, styrene-ethylene-butylene-styrene block thermoplastic elastomer, polyolefin elastomer, thermoplastic polyester elastomer, polyethylene, polypropylene, polystyrene, styrene-acrylonitrile copolymer, acrylonitrile-butadiene-styrene terpolymer, terephthalic acid-tetramethylcyclobutanediol-cyclohexanediol copolymer, polylactic acid, polymethyl methacrylate, polyethylene terephthalate, polycarbonate, polymethylpentene, polyamide, polyvinyl chloride, ethylene-vinyl acetate copolymer, styrene-methacrylate-based copolymer, methyl methacrylate-butadiene-styrene terpolymer, and mixtures thereof, and copolymers thereof.

The polymer can comprise a cationic functional group selected from the group consisting of an ammonium, an iminium, a guanidinium, a phosphonium, a sulfonium, an imidazolium, a thiazolium, pyrazolium, a pyridinium, a pyrrolidinium, a piperidinium, pyridazinium, pyrazinium, and pyrimidinium.

The polymer can comprise an anionic functional group selected from the group consisting of carboxylate, sulfate, and phosphate.

Exemplary polymers comprising a cationic functional group include, but are not limited to poly(dimethyldiallyl amine), poly(allylamine), poly(diallylmethyl amine); poly(ethylene imine), poly-ornithine, poly-arginine, poly-lysine, protamine, chitosan, a charged dendrimer, and a protein. In certain embodiments, the polymer comprises poly(diallyl dimethyl ammonium).

Exemplary polymers comprising an anionic functional group include, but are not limited to poly(styrene sulfonic acid), poly(styrene carboxylic acid), poly(styrene phosphoric acid), poly(acrylic acid), poly(methacrylic acid), poly(vinylsulfonic acid), poly(vinylphosphoric acid), poly(itaconic acid), poly-glutamic acid, alginic acid, dextran sulfonic acid, hyaluronic acid, hydroxypropyl methyl cellulose pectin, heparin, carrageenan, a polynucleic acid, a protein, a charged dendrimer, a charged polymethacrylate, charged silica, a metal oxide. In certain embodiments, the polymer comprises poly(p-styrenesulfonate).

The charged microparticles, charged nanoparticles, and charged small molecules or charged polymers must be charged balanced and exist together with one or more counter ions.

In instances in which the charged microparticles, charged nanoparticles, charged small molecules or charged polymers comprises a negative charge or net negative charge, the counterion can be selected from one or more cations. The type of cation is not particularly limited, and all cations are contemplated by the present disclosure. Exemplary cations include, but are not limited to, NR₄, lithium, sodium, potassium, rubidium, cesium, beryllium, magnesium, calcium, strontium, barium, zinc, silver, iron, copper, lead, tin, mercury, nickel, cobalt, aluminum, and the like, wherein R for each instance is independently hydrogen, alkyl, cycloalkyl, aralkyl, aryl, or heteroaryl; or two instances of R together with the nitrogen to which they are attached form a 3-7 membered heterocyclic or heteroaryl ring.

In instances in which the charged microparticles, charged nanoparticles, charged small molecules or charged polymers comprises a positive charge or net positive charge, the counterion can be selected from one or more anions. The type of anion is not particularly limited, and all anions are contemplated by the present disclosure. Exemplary anions include, but are not limited to, halide (such as fluoride, chloride, bromide, and iodide), hydroxide, oxide, peroxide ion, monohydrogen peroxide ion, sulfide ion, hydrogen sulfide ion, selenide ion, azide ion, carbonate, bicarbonate, nitrite, nitrate, sulfate, hydrogen sulfate, thiosulfate, phosphate, hydrogen phosphate, dihydrogen phosphate, phosphite, silicate, arsenate, chromate, dichromate, permanganate, hypochloride, chlorite, chlorate, perchlorate, bromate, iodate, cyanate ion, thiocyanate ion, cyanide, formate, acetate, oxalate, boron tetrahalide, aluminum tetrahalide, adipate, alginate, ascorbate, aspartate, benzenesulfonate, besylate, benzoate, bisulfate, borate, butyrate, camphorate, camphorsulfonate, citrate, cyclopentanepropionate, digluconate, dodecylsulfate, ethanesulfonate, formate, fumarate, glucoheptonate, glycerophosphate, gluconate, hemisulfate, heptanoate, hexanoate, hydroiodide, 2-hydroxy-ethanesulfonate, lactobionate, lactate, laurate, lauryl sulfate, malate, maleate, malonate, methanesulfonate, 2-naphthalenesulfonate, nicotinate, oleate, oxalate, palmitate, pamoate, pectinate, persulfate, 3-phenylpropionate, phosphate, picrate, pivalate, propionate, stearate, succinate, sulfate, tartrate, p-toluenesulfonate, undecanoate, valerate salts, and the like.

The charged small molecules can be an alkyl silane comprising a cationic functional group or an anionic functional group. In instances in which the alkyl silane comprises a cation functional group, the cationic functional group can be selected from the group consisting of an ammonium, an iminium, a guanidinium, a phosphonium, a sulfonium, an imidazolium, a thiazolium, pyrazolium, a pyridinium, a pyrrolidinium, a piperidinium, pyridazinium, pyrazinium, and pyrimidinium. In instances in which the alkyl silane comprises an anionic functional group, the anionic functional group can be selected the group consisting of carboxylate, sulfate, sulfonate, phosphate, and phosphonate.

In certain embodiments, the alkyl silane has a formula Y(CR¹₂)ₘ Si(R²)(OR³)₂, wherein m is a whole number selected from 1-10, 1-9, 1-8, 1-7, 1-6, 1-5, 1-4, 1-3, 1-2, 2-6, 2-5, 2-4, or 2-3; Y is —COO⁻, —(P═O)(O⁻)₂, —O(P═O)(O⁻)₂, —(S═O)₂O⁻, —O(S═O)₂O⁻, —NR₃⁺, —SR₂⁺, —PR₃⁺, or a cationic heteroaryl, wherein R for each instance is independently hydrogen or alkyl (such as C₁-C₆ alkyl, C₁-C₅alkyl, C₁-C₄ alkyl, C₁-C₃ alkyl, or C₁-C₂ alkyl); R¹ for each instance is independently hydrogen or alkyl; R² is alkyl (such as C₁-C₆ alkyl, C₁-C₅ alkyl, C₁-C₄ alkyl, C₁-C₃ alkyl, or C₁-C₂ alkyl) or —OR³; and R³ for each instance is independently alkyl (such as C₁-C₆ alkyl, C₁-C₅ alkyl, C₁-C₄ alkyl, C₁-C₃ alkyl, or C₁-C₂ alkyl); or two R³ taken together with the oxygen to which they are bonded form 5-6 membered heterocyclic ring.

In certain embodiments, the alkyl silane has a formula NH₃⁺(CH₂)ₘSi(R²)(OR³)₂, wherein m is a whole number selected from 1-10, 1-9, 1-8, 1-7, 1-6, 1-5, 1-4, 1-3, 1-2, 2-6, 2-5, 2-4, or 2-3; R² is alkyl (such as C₁-C₆ alkyl, C₁-C₅ alkyl, C₁-C₄ alkyl, C₁-C₃ alkyl, or C₁-C₂ alkyl) or —OR³; and R³ for each instance is independently alkyl (such as C₁-C₆ alkyl, C₁-C₅ alkyl, C₁-C₄ alkyl, C₁-C₃ alkyl, or C₁-C₂ alkyl). In certain embodiments, the alkyl silane is 3-ammoniumpropyl triethoxysilane or 3-ammoniumpropyl trimethoxysilane.

In instances in which the charged small molecules comprise an alkyl silane, at least some or all of the alkyl silane can undergo a sol-gel reaction when forming the self-assembled charged small molecule monolayers thereby forming self-assembled charged small molecule monolayers comprising a charged polysiloxane.

The charged polymers used in the methods described herein are not particularly limited and all types of charged polymers comprising a negative charge or a positive charge and which are soluble in the solvent are contemplated. In certain embodiments, the charged polymers are a zwitterionic species comprising both negatively charged moieties and positively charged moieties, and which comprise a net positive charge or a net negative charge.

The charged polymers can be a liner charged polymer, a branched charged polymer, or a charged dendrimer. In certain embodiments, the charged polymers are crosslinked.

The charged polymers can comprise one or more repeating units selected from the group consisting of ethylene, propylene, butadiene, styrene, acrylonitrile, carbonate, lactate, acrylate, methacrylate, ethylene glycol, propylene glycol, and vinyl chloride. Exemplary charged polymers comprise polymeric moieties selected from the group consisting of polyurethane, styrene-ethylene-butylene-styrene block thermoplastic elastomer, polyolefin elastomer, thermoplastic polyester elastomer, polyethylene, polypropylene, polystyrene, styrene-acrylonitrile copolymer, acrylonitrile-butadiene-styrene terpolymer, terephthalic acid-tetramethylcyclobutanediol-cyclohexanediol copolymer, polylactic acid, polymethyl methacrylate, polyethylene terephthalate, polycarbonate, polymethylpentene, polyamide, polyvinyl chloride, ethylene-vinyl acetate copolymer, styrene-methacrylate-based copolymer, methyl methacrylate-butadiene-styrene terpolymer, and mixtures thereof, and copolymers thereof.

The charged polymers can comprise a cationic functional group selected from the group consisting of an ammonium, an iminium, a guanidinium, a phosphonium, a sulfonium, an imidazolium, a thiazolium, pyrazolium, a pyridinium, a pyrrolidinium, a piperidinium, pyridazinium, pyrazinium, and pyrimidinium.

The charged polymers can comprise an anionic functional group selected from the group consisting of carboxylate, sulfate, and phosphate. In certain embodiments, the charged polymers comprise poly(diallyl dimethyl ammonium).

The volume ratio of the charged nanoparticle solution to the charged microparticle solution in the solvent can range from 10³-300:1, respectively.

The charged binding material is present in the solvent at a concentration of at least 28 times higher than the concentration of the charged microparticles or the charged nanoparticles. In certain embodiments, the mass ratio of the charged binding material to the charged microparticles can range from 100-1,000:1 or 300-1,000:1, respectively.

The average size of the charged microparticles is at least 1.25 times, 1.5 times, 2 times, 3 times, 4 times, 5 times, 6 times, 7 times, 8 times, 9 times, 10 times, 50 times, 100 times, 200 times, 300 times, 400 times, 500 times, 600 times, 700 times, 800 times, 900 times 1,000 times, 1,500 times, 2,000 times, 5,000 times, 7,000 times, 10,000 times, 15,000 times, 20,000 times, 25,000 times, or 30,000 times larger than the average size of the charged nanoparticles. In certain embodiments, the average size of the charged microparticles is 10-30,000 times, 100-30,000 times, 1,000-30,000 times, 10,000-30,000 times, 15,000-30,000 times, 20,000-30,000 times, 5,000-15,000 times, 10-1,000 times, 50-1,000 times, 100-1,000 times, 200-1,000 times, 300-1,000 times, 400-1,000 times, 500-1,000 times, 600-1,000 times, 700-1,000 times, 800-1,000 times, 900-1,000 times, 10-900 times, 10-800 times, 10-700 times, 10-600 times, 10-500 times, 10-400 times, 10-300 times, 10-200 times, 10-100 times, 50-900 times, 100-800 times, 200-700 times, 300-600 times, 400-500 times, 2-100 times, 2-90 times, 2-80 times, 2-70 times, 2-60 times, 2-50 times, 2-40 times, 2-30 times, 2-20 times, 10-70 times, 10-60 times, 10-50 times, 10-40 times, 10-30 times, 10-20 times, 20-70 times, 20-60 times, 20-40 times, 20-30 times than the average size of the charged nanoparticles.

Since the methods provided herein can be used in connection with any shape of charged microparticles and charged nanoparticles, their shape is not particularly limited. Exemplary shapes include but are not limited to, spherical, hollow, ellipsoidal, polyhedral, rod-shaped, plate-shaped, irregularly shaped, or a mixture thereof.

Since the charged nanoparticles have the opposite charge of the charged binding material, in certain embodiments, the method can further comprise deposition of the charged binding material on a surface of the charged nanoparticles thereby forming a self-assembled charged binding material monolayer comprising the charged binding material disposed on the surface of the charged microparticles. In certain embodiments, the deposition of the charged binding material monolayer can change the shape of the charged nanoparticles. For example, deposition of the charged binding material monolayer can change the shape of spherically shaped or irregularly shaped charged nanoparticles to ellipsoidal, polyhedral, rod-shaped, or plate-shaped charged nanoparticles.

The preparation of the hierarchical core-satellite particles can be conducted in any solvent in which the charged microparticles and the charged nanoparticles are insoluble and the charged binding material is soluble. The selection of the appropriate solvent will depend on the physical/chemical properties of the charged microparticles, the charged nanoparticles, and the charged binding material. In certain embodiments, the solvent comprises water.

In certain embodiments, the solvent is an oil continuous phase comprising one or more water-in-oil micro-droplets comprising the charged microparticles, the charged nanoparticles, the charged binding material, and water.

It was advantageously discovered that when the method described herein is conducted in mono-dispersed water-in-oil micro-droplets prepared using a microfluidic device up to 10⁴ hierarchical core-satellite particles can be prepared per batch.

The oil continuous phase that can be used in step can be any oil phase that is substantially immiscible with water and can generate a stable water-in-oil droplet. In certain embodiments, the oil phase is an oil, a non-polar solvent, a fluorinated oil, a silicone oil, a rapeseed oil, a mineral oil, a fluorinated surfactant, a fluorocarbon, a silicone oil, decane, tetradecane, hexadecane, a commercial droplet oil (also known as a droplet generation oil), such as Biorad droplet-forming oil, and the like, or any combination thereof. Suitable oil phases are known to those skilled in the art in which the aqueous phase spontaneously leads to the formation of water droplets or isolated volumes or compartments surrounded by the oil phase.

In certain embodiments, the oil phase further comprises one or more surfactants. The surfactant can be sorbitan-based carboxylic acid esters, such as sorbitan monolaurate (Span 20), sorbitan monopalmitate (Span 40), sorbitan monostearate (Span 60), sorbitan monooleate (Span 80), Tween 20 (polysorbate 20), and Tween 40 (polysorbate 40), polyoxyethylenated alkylphenols, such as Triton X-100, polyoxyethylenated straight chain alcohols, polyoxyethylenated polyoxypropylene glycols, polyoxyethylenated mercaptans, long chain carboxylic acid esters, Triton X-100, etc., or a fluorine-containing surfactant.

As illustrated in FIG. 4, the one or more water-in-oil micro-droplets can be formed by combining a first water feed comprising the charged microparticles and a second water feed comprising the charged nanoparticles and the charged binding material in the presence of one or more oil feeds thereby forming the water-in-oil micro-droplets.

The methods described herein are useful for preparing hierarchical core-satellite particles that find application in for drug delivery, photonics, chemical sensing, energy storage and/or catalysis.

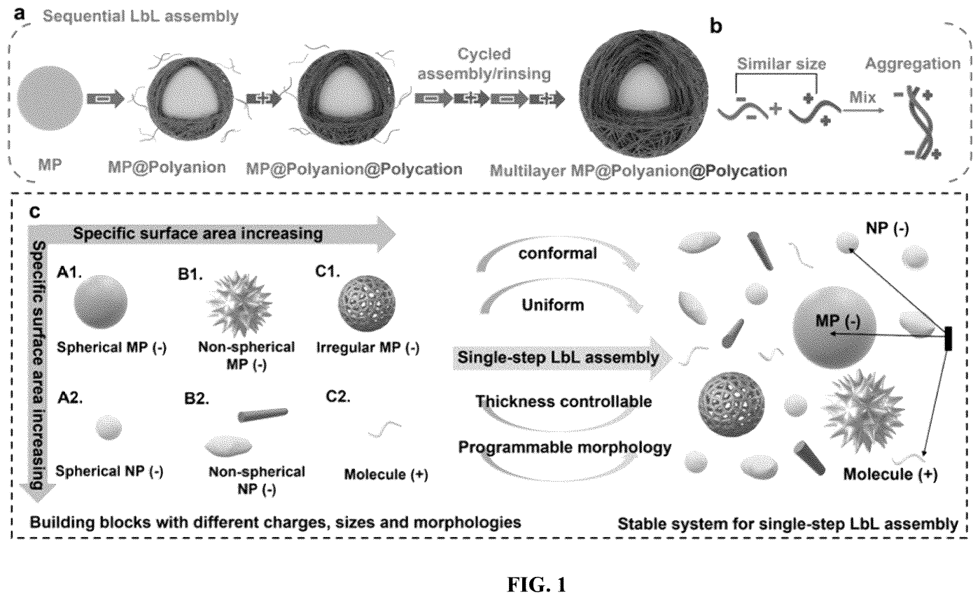

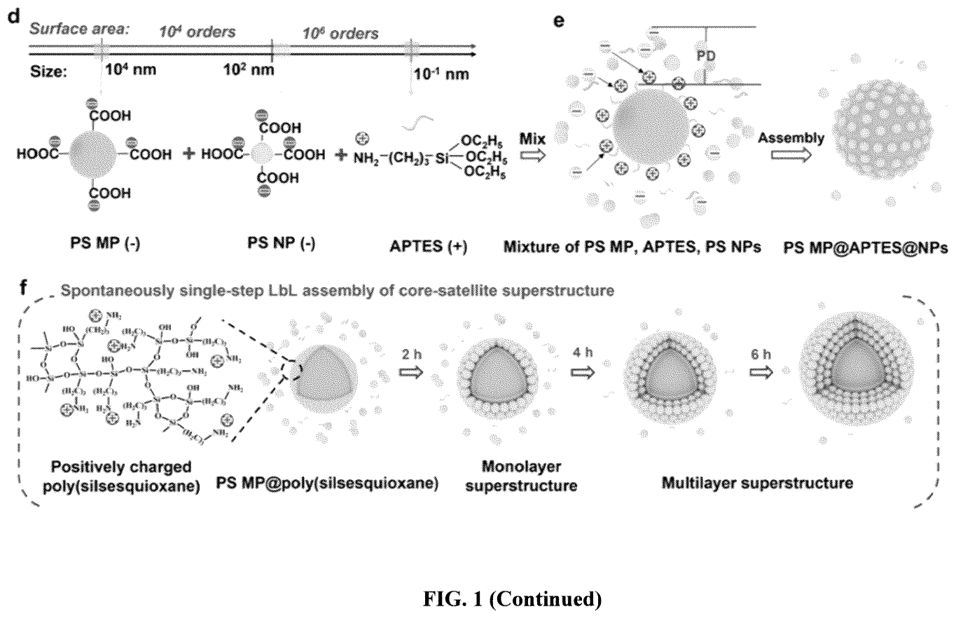

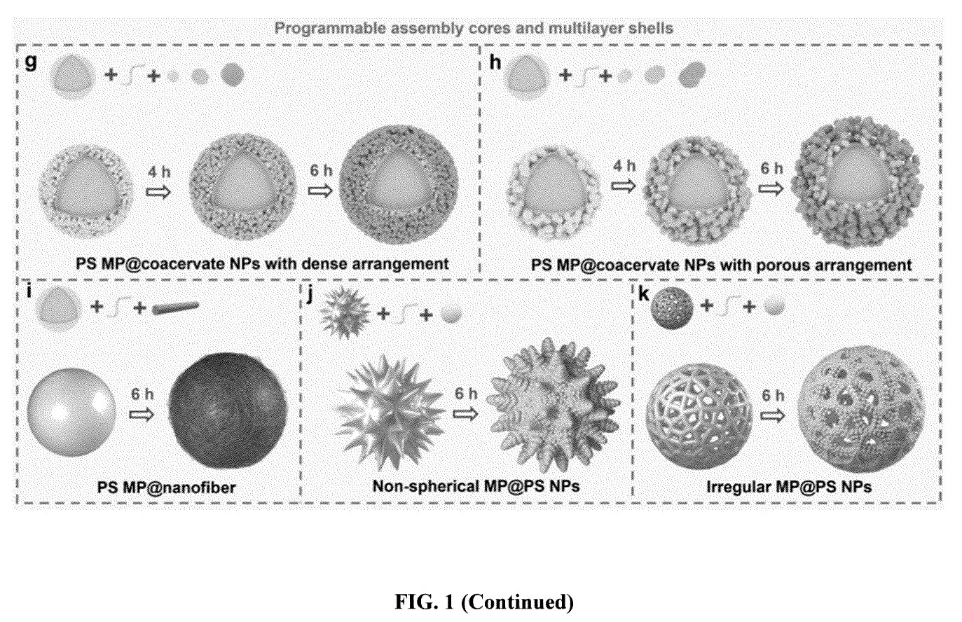

Herein, a novel stable state was explored to generate varied suspended functional assemblies without forming the aggregations when mixing the opposite charged building blocks with different specific surface area and geometries (FIG. 1c). On this basis, we further explored versatile mechanism of single-step LbL assembly to achieve a high-level morphological control of above building blocks, in which NPs and molecules spontaneously assemble around the MPs cores to form multicomponent core-satellite superstructures, the core geometry, nanoshell uniformity, thickness, and arrangement can be programmatically configured on demand. A ternary system consisting of negative charged PS MPs (10 μm) and PS NPs (80 nm), and positive charged small molecules (APTES ˜0.1 nm) is conducted to illustrate the assembly mechanism, due to distinct length scales of specific surface area among them (˜10¹⁰ orders of magnitude) (FIG. 1c-d). The interface electrostatic interaction across different length scales of approximately 10¹⁰ orders of magnitude was investigated, to reveal that when the concentration of APTES was lower than that of MPs or NPs for ˜10⁴ times, the addition of oppositely charged small molecules does not cause rapid aggregations of each binary mixed dispersion of PS NPs/APTES or PS MPs/APTES. Interestingly, negatively charged MPs and NPs continuously absorbed APTES on their surfaces until their charges reversed to positive, causing each mixed dispersion to gradually transition from a stable suspension to a suspended assembly of several particles and eventually to an unstable sedimentation state. Because the specific surface area of individual NPs was larger than that of individual MPs by ˜10⁴ times, in a solution with homogeneous APTES, resulting in MP surface change reversal to be positive preferentially. At the same time, because NP surface charge remained negative, small molecule-mediated interparticle PD caused NPs to assemble around MPs, forming a superstructure with core (MP)-satellite (NPs) architecture (FIG. 1e) through a single-step LbL assembly. To demonstrate the universality of this approach, variety core-satellite architectures were constructed by assembling different building blocks, such as positive charged polymer PDDA, negatively charged silica MPs (1, 2 μm) and charged silica NPs (30, 200, 500, 800 nm).

Notably, only small molecule-mediated driving PD force did not allow many NPs to assemble around the MPs cores to form the uniform LbL configurations. In fact, a dense network of cross-linked poly(silsesquioxane) was necessary to be pre-coated on the MPs, which endowed a positive equipotential density on the outermost layer to induce a well-defined LbL equipotential configurations, consisting uniform multilayers of APTES (positive equipotential) and NP coating (negative equipotential) around the MP core. In addition, because APTES was continuously consumed from dispersion during the assembly process, the equipotential difference (EPD) between APTES and the nanocoatings decreased as the number of layers increased to form the assembles with well-defined multilayer configurations. As EPD decreased gradually, the NPs preferred to assemble on the previous assembled APTES layer rather than other layers, ensuring that opposite charged NPs and APTES are deposited spontaneously and alternatively around the MPs cores in a LbL manner as assembly time increases, resulting in the construction of superstructures with conformal, uniform and thickness-controllable nanoshells (FIG. 1f).

By using coacervate NPs to replace the PS NPs in the above ternary systems, another ternary system consisting of negatively charged PS MPs (10 μm), positively charged small molecules (APTES ˜0.1 nm) and coacervate NPs is obtained. Since coacervate NPs were electrostatically complexed from APTES and PS, the low concentration APTES not only provided decreasing EPD to facilitate spontaneous LbL assembly, but also electrostatically complexed with coacervate NPs in the dispersion to change NP geometry from spherical to rod-like, thus forming different multilayer nanoshells ranging from dense to porous arrangements (FIG. 1g-h). Furthermore, the single-step LbL process eliminates repetitive rinsing and the resultant surface tension and capillary forces, making it more versatile and allowing programmable combinations of different cores and multilayer nanoshells into novel LbL-coated configurations, without limiting the composition and geometries of NPs and MPs. Various core-satellite superstructures assembled from programmable ternary systems composed of non-spherical building blocks have been demonstrated, such as nanofibers as shells or stabbing, skeletonized porous MPs as cores (FIG. 1i-k).

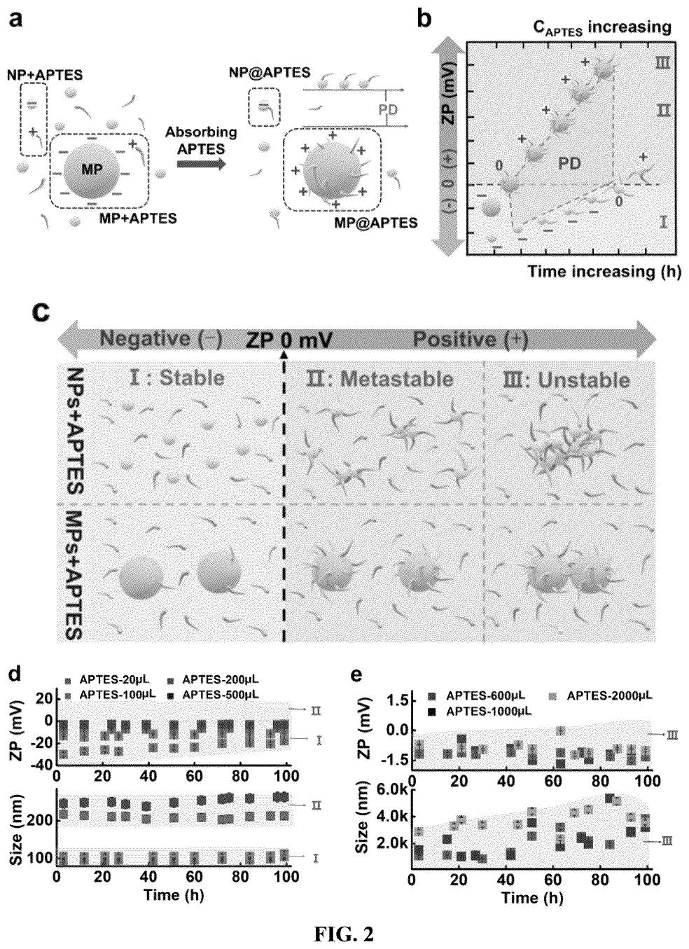

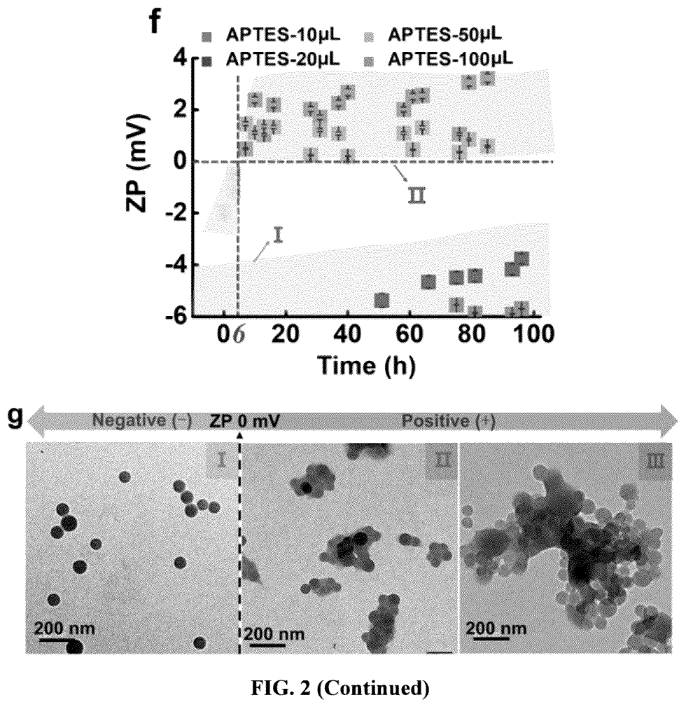

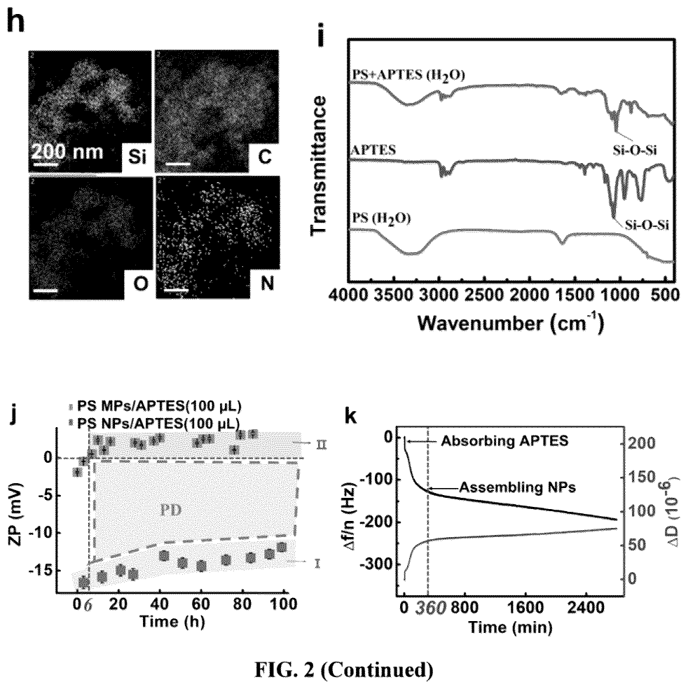

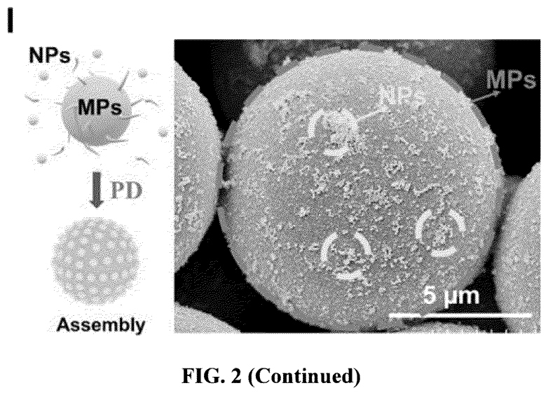

The single-step LbL mechanism from binary mixed dispersions of PS NPs/APTES or PS MPs/APTES is first illustrated. Positively charged APTES can be continuously absorbed on the surface of negatively charged PS MPs and NPs and form PS MP@APTES and PS NP@APTES by electrostatic attraction (FIG. 2a). The charges of both particles tend to gradually reverse to positive charges and their suspended state varies with time and APTES concentration introduced (FIG. 2b). Each binary system undergoes (I) a stable suspended state: no charge reversal and particle sedimentation, (II) a metastable state: charge reversal and suspended assembly of several particles and (III) an unstable state: charge reversal and sedimentation of most particles (FIG. 2c). Since the different individual specific surface areas between PS MP and NP result in different adsorption capacities of APTES on their surfaces, it is possible to find a certain APTES concentration range to make the charge of PS MP@APTES reverses to a positive charge in the metastable state (II), while PS NP@APTES simultaneously maintains a negative charge in the stable state (I). Thus, APTES-mediated interparticle PD between PS MP@APTES and PS NP@APTES is the main driving force for the assembly (FIG. 2a, b).

In the case of NPs/APTES binary system, when adding low concentration of APTES (˜100 μL), zeta potential of the mixed dispersion increased rapidly from −21.1±0.2 to −14.3±0.3 mV, indicating the formation of PS NP@APTES. Then, the zeta potential of PS NP@APTES increased continuously from −14.3±0.3 to −10.9±0.2 mV within 100 h, whereas the size of PS NP@APTES remained constant with time, to be ˜106±0.3 nm in diameter. This indicates that 100 μL of APTES solution is not sufficient to reverse the charge of PS NP@APTES to be positive, PS NP@APTES remain negatively charged and interparticle electrostatic repulsion result in a stable suspension without any aggregates (FIG. 2c, State I). When increasing the concentration of APTES solution from 200 to 500 μL, more APTES is absorbed on the surface of PS NP@APTES. The zeta potential of the mixed dispersion increases to approach zero but remains negative within 100 h (FIG. 2d). Moreover, large negatively charged region is observed in the zeta potential distribution curve, suggesting that a small amount of negatively charged PS NP@APTES reverse to be positive charged, while most PS NP@APTES remain negatively charged. The electrostatic attraction between the positively charged PS NP@APTES and negatively charged PS NP@APTES leads to aggregates. Due to the average size of the aggregates (˜258±12 nm) is nearly twice the size of the individual PS NPs (˜106±0.3 nm) (FIG. 2d), their gravity was not enough to make them sink, but they were maintained in a suspended assembly state (FIG. 2c, State II). When increasing the APTES concentration to a certain range (600 μL to 2000 μL), the absorption of sufficient APTES contributes to reverse the mostly negatively charged PS NP@APTES to be positive, a large positive charged region is observed in zeta potential distribution curve, and zeta potential of the mixed dispersions tends to cross zero within 100 h (FIG. 2e). The strong electrostatic attraction between the mostly positively charged PS NP@APTES and the negatively charged PS NP@APTES result in significant aggregates with irregular size distribution (FIG. 2e), further leading to an unstable sedimentation state (FIG. 2c, State III).

The PS NP@APTES in different states are recorded under a Transmission Electron Microscopy (TEM)(FIG. 2g). When APTES amount is below 500 μL (I state), well dispersed nanoparticles (˜50 nm in diameter) are observed. When APTES amount is in a range between 600-2000 μL to reach metastable state (II state), the small aggregations (200-500 nm in diameter) are observed. However, when APTES amount is above 2000 μL to approach an unstable sedimentation state (III state), large irregular aggregations (˜1000 nm in diameter) are observed. In addition, the surface roughness of PS NP@APTES is measured by TEM to show the NP surface roughness increased when absorbing APTES by time. EDS results showed the elemental distribution of N, Si, O and C in PS@APTES NPs (FIG. 2h). Attenuated total reflectance (ATR)-FTIR spectra of PS@APTES NPs indicated the Si—O—Si bonds on particle surface at 1080 cm⁻¹ (FIG. 2i) to demonstrate that the APTES absorbed on NPs lead to above three states of binary system.

For the binary systems of PS MPs/APTES, similar three states were observed (FIG. 2c). However, because the individual specific surface area of PS NPs is much larger than that of PS MPs for ˜10⁴ times, when adding the same APTES concentration, higher APTES density on the PS MP surface than that of PS NPs PS NPs was allowed. Therefore, compared with PS NP@APTES, the PS MP@APTES preferentially reverse from negative to positive to reach the metastable state (II state), but the charge of the PS NPs@APTES remains negative (I state). For example, in NPs/APTES systems, adding small amount of APTES solution (100 μL) is insufficient to reverse the zeta potential (FIG. 2d), while in MPs/APTES systems, it has already been sufficient to reverse the zeta potential (FIG. 2f). The zeta potential of PS MP@APTES increases to −1.06±0.3 mV within 5 h and begins to cross zero point after the next 63 h to a positive value of +2.72±0.5 mV (FIG. 2f).

For the ternary systems of NPs/MPs/APTES, adding 100 μL of APTES solution is ideal to mediate the interparticle PD between the positively charged PS MP@APTES and negatively charged PS NP@APTES (FIG. 2j). The APTES-mediated interparticle PD can drive the negatively charged PS NP@APTES assemble around the positively charged PS MP@APTES cores, forming the core-shell structured assembles. A quartz crystal microbalance with dissipation (QCM-D) was used to monitor the ternary assembly process in real time. As the mass of the crystal chip increases due to adsorption, the resonance frequency (Δf) decreases, while the energy dissipation parameter (ΔD) provides information about the viscoelastic energy of the adsorbed layer. After the mixed dispersion of APTES and PS NPs was injected into the chamber for 360 min, the QCM-D results show the Δf keeps decreasing with a significant slope, indicating that the positively charged APTES is rapidly absorbed on the negatively charged PS MPs deposited on chip (FIG. 2k). After that, the Δf decreasing slope became moderated, because APTES-mediated PD was formed and the driving force was reduced by PD. As a result, the NP was driven to slowly assemble on the outermost layer of PS MP@APTES (FIG. 2l). The ΔD increased correspondingly during the assembly (FIG. 2k). The PD formation time of 360 min in the ternary system (FIG. 2k) was approximately consistent with the charge reversal time of 6 h in the PS MPs/APTES binary system (FIG. 2f), further demonstrating that PD was mediated by APTES.

It is worth noting that the non-uniform distribution of carboxyl groups on PS MPs surface endowed non-equipotential negative densities on the outermost layer, which after adsorption of APTES further lead to non-equipotential positive densities on the outermost layer of PS MP@APTES. The PS NPs were sparsely and randomly assembled on the surface of PS MPs (FIG. 2l) to form a non-uniform layer with time. The experimental results suggest that molecule-mediated PD can offer a driven force to assemble NPs on MPs, while another engineering procedure is required to construct the NPs/MPs/APTES ternary assemblies with uniform layer by layer (LbL) configurations.

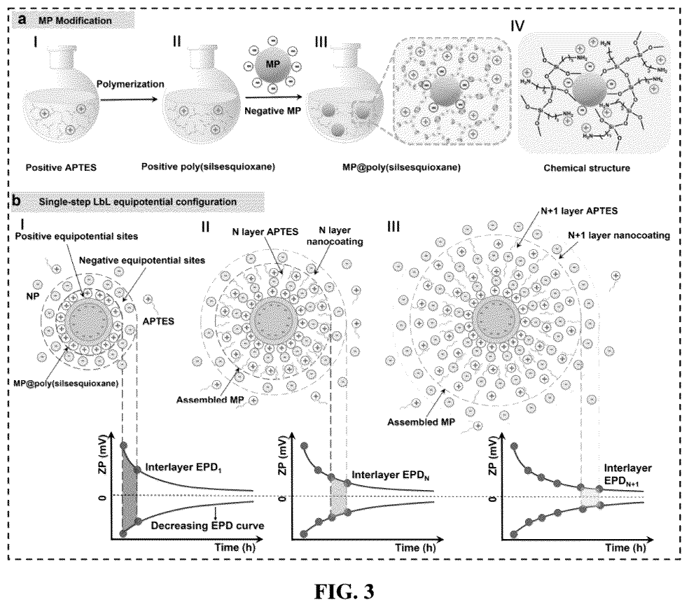

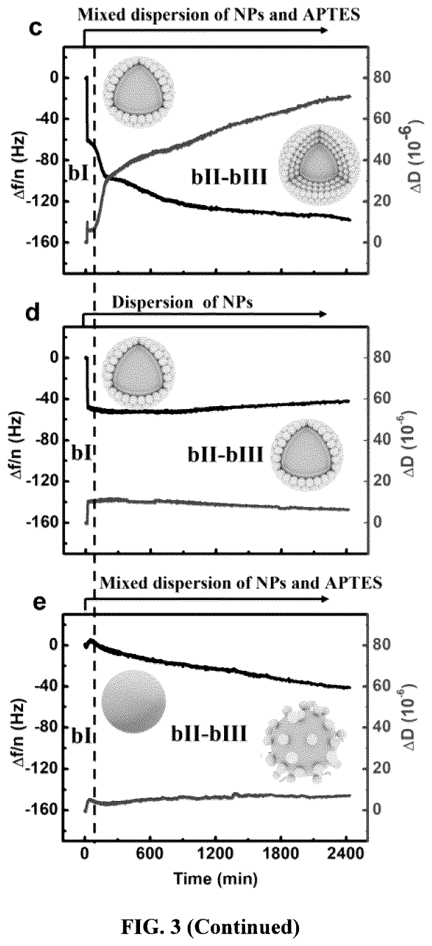

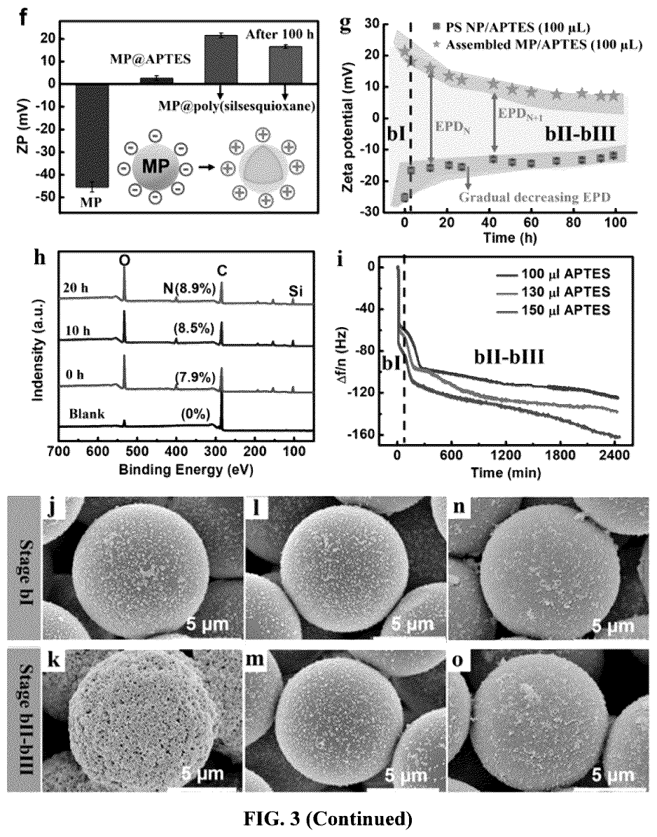

To induce a well-defined LbL configurations of NPs around the MP core, the construction of initial equipotential sites on the outermost layer of PS MP (FIG. 3a) is necessary. Accordingly, before assembling NPs, the positive charged APTES molecules were polymerized into a poly(silsesquioxane) network (FIG. 3a, I-II) on PS MP. The negatively charged PS MP surface was therefore modified by positively charged poly(silsesquioxane) APTES network (FIG. 3a, III). Due to the electrostatic attraction and condensation reaction of Si—O—Si bonds, a stable, uniform and dense poly(silsesquioxane) network was coated on the PS MP surface (FIG. 3a, IV) to form PS MP@poly(silsesquioxane). This APTES poly(silsesquioxane) thin layer with positive equipotential sites would ensure the equal negative potential between n and n+1 layer of NP coating to mediate uniform LbL coating.

The thickness of resultant APTES poly(silsesquioxane) thin layer was tens of nanometers after 100 h of immersion in water. During coating, the zeta potential of PS MP@poly(silsesquioxane) was gradually increased from −45.5±2 mV to +21.6±0.2 mV in 24 hr and remained at +26.6±0.5 mV after 100 h of immersion. Notably, the zeta potential of PS MP@poly(silsesquioxane) was higher than that of raw PS MP (+2.72±0.5 mV) mediated by APTES (FIG. 3f). The dense and uniform poly(silsesquioxane) network offered equipotential sites on PS MPs@poly(silsesquioxane) to ensure following LbL NP coating with uniform configuration.

Certain embodiments of the method described herein are illustrated in FIG. 3b. When mixing PS MP@poly(silsesquioxane), PS NPs and APTES, the LbL equipotential configurations was spontaneously constructed in three steps: First, the PS MPs@poly(silsesquioxane) with the positive equipotential sites absorbed a uniform monolayer of negatively charged PS NP@APTES nanocoating, which subsequently developed the negative equipotential sites around the outermost layer (FIG. 3b, I). Second, the as-formed nanocoating with negative equipotential sites absorbed monolayer of positively charged APTES in dispersion for charge reversal, ensuring that the positive equipotential sites is used to assemble the next uniform nanocoating (FIG. 3bII). Third, the alternate positive and negative equipotential sites would be continuously constructed around the cores to develop the LbL configurations spontaneously (FIG. 3b, II-III). The alternating positive and negative equipotential sites between each APTES layer and nanocoating contributed to develop the interlayer equipotential difference (EPD) to ensure the uniformity of assembled nanocoating. When the NP layer number increased, the positive potential was gradually decreased by APTES coated, resulting in a gradual decrease in EPD by coated NP layers, i.e. EPD₁>EPD_{N}>EPD_{N+1}. Notably, gradually decreasing EPD played an important role in the spontaneous assembly of PS NPs and APTES around PS MP@poly(silsesquioxane) core without forming random aggregations to develop LbL configurations.

QCM-D was used to monitor the nanocoating assembly process in real time. By measuring the dynamic changes of QCM frequencies to indicate the driving force of interlayer EPD, three stages were indicated: 1. a rapid deposition of a monolayer nanocoating (stage bI); 2. the multilayer nanocoatings gradually assembled by NPs (stage bII); 3. stable LbL configurations (stage bIII) (FIG. 3c). When mixing PS NPs and APTES (100 μL) in Stage bI, high interlayer EPD between outermost layer of PS MP@poly(silsesquioxane) and NP@APTES was established due to positive equipotential poly(silsesquioxane) network, which facilitated a significant electrostatic attraction to construct a monolayer of NPs@APTES. It was observed that Δf decreased dramatically in several minutes, indicating the positive equipotential charged PS MP@poly(silsesquioxane) quickly adsorb negatively charged NP@APTES. Accordingly, a uniform monolayer of PS NP@APTES assembled on the PS MP@poly(silsesquioxane) surface was observed under SEM (FIG. 3j). After that, in stage bII, the interlayer EPD was mediated by positive APTES to form a LbL configuration. The APTES-mediated EPD provided a weak electrostatic attraction to continuously assemble the PS NP@APTES on MP to show a slow decrease in Δf. Accordingly, ΔD was continuously increased and a thick uniform nanocoating was observed (FIG. 3k). Finally, in stage bIII, the EPD approached to zero to show a mild Δf decrease, indicating the formation of a stable LbL coating.

In stage bII and bIII, the zeta potential of positive charged MP@poly(silsesquioxane) gradually decreased when assembling negative charged NP@APTES. The consumption of APTES molecules during coating resulted to a gradual interlayer EPD decrease, when the number of nanocoating layer increased (EPD_{N}>EPD_{N+1}). As the EPD_{N} was larger than EPD_{N+1}, the electrostatic attraction between the APTES and the NP@APTES on nth layer was larger than that on (n+1)th layer. Therefore, the NP@APTES would spontaneously anchor on the nth layer rather than the (n+1)th layer to construct a well-defined LbL configurations around MP cores. The zeta potential of the nanocoated MPs therefore decreased over time, while remained to be positive (FIG. 3g, upper line).

In addition, the zeta potential of NPs in an APTES dispersed system gradually increased with time. The positively charged APTES molecules were continuously adsorbed on the negatively charged NPs to decrease the interlayer EPD between the MP and NP (FIG. 3g, bottom line), and the trend was consistent with our LbL assembly model (FIG. 3b). Notably, based on the different specific surface area between the MP and NP, 100 μL APTES was optimal to ensure the positive charged MP (metastable state), while to keep negative charged NP (stable state) for assembly. The compositions of the nanocoated shells formed were investigated by XPS at 10 and 20 h (FIG. 3h) respectively to show an increase in nitrogen content, further validating the assembly mechanism of EPD decrease when consuming APTES over time. In QCM tests, when increasing APTES amount, the EPD between the MP and the NP would be enhanced to increase the rate of assembly to show a dramatic Δf decreasing trending by time in the stage of bII-bIII (FIG. 3i).

The control experiments were conducted by characterizing two systems (NPs/MPs@poly(silsesquioxane) and NPs/MPs/APTES) through QCM tests to validate the mechanism of APTES mediated assembly. In the case of NPs/MPs@poly(silsesquioxane), due to electrostatic attractions between NPs and MPs@poly(silsesquioxane), the monolayer nanocoating was formed around the MP cores, while LbL configurations were not developed. When NPs were dispersed into the chip surface deposited with PS MPs@poly(silsesquioxane), Δf decrease was observed in several minutes (FIG. 3d) to indicate the formation of monolayer nanocoating in stage bI. The morphology of monolayer nanocoating on the MPs cores was observed under the SEM (FIG. 3l). Compared with the MP@poly(silsesquioxane)/NPs/APTES system introduced before (FIG. 3c), Δf and the nanocoating thickness were unchanged with time in stage bII-bIII (FIG. 3m). The zeta potential of the MP@poly(silsesquioxane)/NPs remained negatively charged. Indeed, without APTES to mediate EPD between MPs and NPs, the driven forces to attract MPs and NPs in the outmost layer could not be generated, and the LbL configurations were not developed.

In the case of NPs/MPs/APTES, when uploading NPs and APTES to the hip surface deposited with unmodified MPs, a sharp Δf decrease was not observed in stage bI (FIG. 3e). Instead of that, a smooth Δf decrease by time was obtained and the boundaries to distinguish different stages were not observed. Accordingly, through SEM, it was found that most NPs were sparsely deposited on MPs (FIG. 3n). Consistently, the thickness of nanocoating was almost unchanged after 40 h incubation (FIG. 3o). Notably, without modifying MP surface through APTES coated poly(silsesquioxane) network, the EPD only mediated by suspended APTES in a solution was not sufficient to construct LbL configurations, resulting in the inability of absorption of NPs around the MP cores. By systematically characterizing NPs/MPs@poly(silsesquioxane) and NPs/MPs/APTES, it was found that the existence of both suspended APTES and APTES coated poly(silsesquioxane) metwork on MP surface are critical to develop LbL configurations around MP cores, forming well-defined multilayer superstructures.

What is claimed is:

1. A method of preparing hierarchical core-satellite particles, the method comprising: contacting charged microparticles comprising a first charge, charged nanoparticles comprising a second charge, and a charged binding material selected from the group consisting of charged small molecules and charged polymers, wherein the charged small molecules or the charged polymers comprise a third charge in a solvent, whereby:
(a) the charged binding material self-assembles on a surface the charged microparticles thereby forming a first self-assembled charged binding material monolayer comprising the charged binding material disposed on the surface of the charged microparticles;
(b) the charged nanoparticles self-assemble on a surface of the self-assembled charged binding material monolayer thereby forming a first self-assembled charged nanoparticle monolayer comprising the charged nanoparticles disposed on the surface of the first self-assembled charged binding material;
(c) the charged binding material optionally self-assembles on the first self-assembled charged nanoparticle monolayer thereby forming a second self-assembled charged binding material monolayer comprising the charged binding material disposed on the surface of the first self-assembled charged nanoparticle monolayer;
(d) the charged nanoparticles optionally self-assemble on a surface of the second self-assembled charged binding material thereby forming a second self-assembled charged nanoparticle monolayer comprising the charged nanoparticles disposed on the surface of the second self-assembled charged binding material monolayer; and
(e) optionally repeating step (c) or steps (c) and (d) one or more times;
thereby forming the hierarchical core-satellite particles, wherein the first charge and the second charge are both positively charged or negatively charged, the third charge is the opposite charge of the first charge and the second charge, and the average size of the charged microparticles is at least about 10³ times larger than the average size of the charged nanoparticles.

2. The method of claim 1, wherein the method is conducted in one reaction vessel in a single step.

3. The method of claim 1, wherein the charged microparticles and the charged nanoparticles independently comprise charged silica, a metal oxide, or a polymer comprising at least one of a cationic functional group and an anionic functional group.

4. The method of claim 3, wherein the cationic functional group is selected from the group consisting of an ammonium, an iminium, a guanidinium, a phosphonium, a sulfonium, an imidazolium, a thiazolium, pyrazolium, a pyridinium, a pyrrolidinium, a piperidinium, pyridazinium, pyrazinium, and pyrimidinium; and the anionic functional group is selected from the group consisting of carboxylate, sulfate, and phosphate.

5. The method of claim 3, wherein the polymer comprises poly(dimethyldiallyl amine), poly(allylamine); poly(diallylmethyl amine); poly(ethylene imine), poly-ornithine, poly-arginine, poly-lysine, protamine, chitosan, a protein, poly(styrene sulfonic acid), poly(styrene carboxylic acid), poly(styrene phosphoric acid), poly(acrylic acid), poly(methacrylic acid), poly(vinylsulfonic acid), poly(vinylphosphoric acid), poly(itaconic acid), poly-glutamic acid, alginic acid, dextran sulfonic acid, hyaluronic acid, hydroxypropyl methyl cellulose pectin, heparin, carrageenan, a polynucleic acid, a protein, or a charged dendrimer.

6. The method of claim 3, wherein the metal oxide is a Group 3-16 metal oxide.

7. The method of claim 1, wherein the charged small molecules are an alkyl silane comprising a cationic functional group or an anionic functional group.

8. The method of claim 7, wherein the cationic functional group is selected from the group consisting of an ammonium, an iminium, a guanidinium, a phosphonium, a sulfonium, an imidazolium, a thiazolium, pyrazolium, a pyridinium, a pyrrolidinium, a piperidinium, pyridazinium, pyrazinium, and pyrimidinium; and the anionic functional group is selected from the group consisting of carboxylate, sulfate, sulfonate, phosphate, and phosphonate.

9. The method of claim 7, wherein the alkyl silane has a formula Y(CR¹₂)ₘ Si(R²)(OR³)₂, wherein m is a whole number selected from 1-10; Y is —COO⁻, —(P═O)(O⁻)₂, —O(P═O)(O⁻)₂, —(S═O)₂O⁻, —O(S═O)₂O⁻, —NR₃⁺, —SR₂⁺, —PR₃⁺, or a cationic heteroaryl, wherein R for each instance is independently hydrogen or alkyl, R¹ for each instance is independently hydrogen or alkyl; R² is alkyl or —OR³; and R³ for each instance is independently alkyl; or two R³ taken together with the oxygen to which they are bonded form 5-6 membered heterocyclic ring.

10. The method of claim 7, wherein the alkyl silane has a formula NH₃⁺(CH₂)ₘSi(R²)(OR³)₂, wherein m is a whole number selected from 1-10, R² is alkyl or —OR³; and R³ for each instance is independently alkyl.

11. The method of claim 9, wherein the alkyl silane undergoes a sol-gel reaction.

12. The method of claim 1, wherein the charged microparticles and charged nanoparticles are a polymer comprising sulfonate or —NR₃⁺ and the charged small molecules are an alkyl silane has a formula NH₃(CH₂)ₘSi(OR³)₃, wherein m is a whole number selected from 1-10 and R³ for each instance is independently alkyl; or the charged microparticles and charged nanoparticles are negatively charged silica and the charged polymer comprises —NR₃⁺, wherein R for each instance is independently hydrogen or alkyl.

13. The method of claim 1, wherein the charged binding material is present in the solvent at a concentration of at least 10³ times less than the concentration of the charged microparticles or the charged nanoparticles.

14. The method of claim 1, wherein the solvent is water.

15. The method of claim 1, wherein the solvent is an oil continuous phase comprising one or more water-in-oil micro-droplets comprising the charged microparticles, the charged nanoparticles, the charged binding material, and water.

16. The method of claim 15, wherein the one or more water-in-oil micro-droplets are produced by a microfluidic device.

17. The method of claim 1, wherein the charged microparticles and the charged nanoparticles are independently spherical, hollow, ellipsoidal, polyhedral, rod-shaped, plate-shaped, irregularly shaped, or a mixture thereof.
